(19) United States
(12) Patent Application Publication
(10) Pub. No.: US 2026/0286941 A1
(43) Pub. Date: Sep. 24, 2026

(54) PONDLESS HYDROMECHANICAL STORAGE SYSTEM

(71) Applicant: Sage Geosystems Inc., Houston, TX (US)

(72) Inventors: Robert Lance COOK, Houston, TX (US); Douglas SIMPKINS, Houston, TX (US); Lev M. RING, Bellaire, TX (US)

(21) Appl. No.: 19/474,059

(22) PCT Filed: Apr. 19, 2024
(86) PCT No.: PCT/US2024/025493

§ 371 Date: Oct. 9, 2025

Related U.S. Application Data
(60) Provisional application No. 63/497,657, filed on Apr. 21, 2023.

(51) Int. Cl. F03B 13/10; F03G 4/02

(52) U.S. Cl. CPC F03G 4/026; E21B 41/00; E21B 41/0085; F03B 13/10; F03G 4/001; F03G 4/02; F03G 4/033; F24T 10/20; F24T 10/30; Y02E 10/10

(57) ABSTRACT

A first fluid is produced from a first subterranean formation, and the fluid is used to generate electricity and/or heat a second fluid. The first fluid is injected into a second subterranean formation that is different from the first subterranean formation. The first fluid is transferred from the second subterranean formation to the first subterranean formation. In some implementations, the first fluid is produced from the first subterranean formation at a first zone of a well, and is injected into the second subterranean formation at a second zone of the well. In some implementations, the generation of electricity using the first fluid is performed with an electrical submersible generator installed in the well. In some implementations, the transfer of the first fluid from the second subterranean formation to the first subterranean formation is performed using the electrical submersible generator as a pump.

### CROSS-REFERENCE TO RELATED APPLICATIONS

This application is an International Patent Application under the Patent Cooperation Treaty and claims priority to and the benefit of U.S. Provisional Patent Application Ser. No. 63/497,657 filed Apr. 21, 2023 and titled Pondless Hydromechanical Storage System, the disclosure of which is incorporated herein in its entirety by this reference.

### BACKGROUND

### Field

Embodiments of the present disclosure generally relate to power systems and processes, such for geothermal power systems. Embodiments relate particularly to the recovery of pressure energy and geothermal heat energy to perform useful work, such as generating electricity.

### Description of the Related Art

Geothermal energy is a type of renewable energy generated within the earth. A geothermal fluid (such as water, steam, brine, or hydrocarbons) is heated in a subterranean geological formation by the earth's natural internal temperature. The heated geothermal fluid is produced to the earth's surface. The enthalpy of the geothermal fluid includes a heat energy component and a pressure-volume energy component. Typically, the heat energy component is greater than the pressure-volume energy component. At the earth's surface, the heat energy component is used to perform useful work, such as heating buildings or generating electricity in a geothermal power system. However, the pressure-volume energy component is usually wasted, such as by venting. After performing useful work, the geothermal fluid is reinjected into the subterranean formation, reheated by the subterranean formation, then produced again to the earth's surface to perform useful work.

Some geothermal power systems generate electricity by using the geothermal fluid to drive a steam turbine. However, where the produced geothermal fluid is at or below about 180 degrees C, geothermal power systems typically incorporate a binary cycle power plant to generate electricity. A heat exchanger of the binary cycle power plant transfers heat, but not pressure, from the geothermal fluid to a working fluid of the binary cycle power plant.

In an example, operation of the binary cycle power plant is based on the Brayton Cycle, in which the heated working fluid passes through a turbine, which drives a generator. In another example, operation of the binary cycle power plant is based on the Organic Rankine Cycle, in which the heated working fluid passes through an expander, which drives a generator. Typically, binary cycle power plants utilize only the heat energy component of the enthalpy of the geothermal fluid. The pressure-volume energy component is wasted, such as by venting.

The efficiency of a geothermal power system depends on the amount of energy (in the form of heat energy and pressure-volume energy) that can be transferred from the subterranean geological formation to the geothermal fluid, and depends on the proportion of that energy that is converted into useful work. Typically, the efficiency of converting geothermal energy (in the form of heat energy plus pressure-volume energy) into electricity is less than 15 percent.

The operation of some power systems, including some geothermal power systems, requires extensive fluid storage at the earth's surface, such as in ponds. Such storage can occupy a large area of land, can present an environmental pollution risk, and can be expensive to maintain.

There is a need for improved systems and processes that facilitate the conversion of fluid pressure energy into electricity. There is a need for improved systems and processes that facilitate the conversion into electricity of fluid pressure energy and heat energy, such as in geothermal energy power systems, while mitigating the need for extensive fluid storage at the earth's surface.

### SUMMARY

The present disclosure generally relates to power systems and processes, such for geothermal power systems. Embodiments relate particularly to the recovery of pressure energy and geothermal heat energy to perform useful work, such as generating electricity. In one implementation, a method of operating a power system includes producing a first fluid from a first subterranean formation, and generating electricity using the first fluid. The method further includes injecting the first fluid into a second subterranean formation different from the first subterranean formation, and transferring the first fluid from the second subterranean formation to the first subterranean formation.

In another implementation, a method of operating a power system includes producing a fluid from a first subterranean formation at a first zone of a well, flowing the fluid through an impeller section of an electrical submersible generator installed in the well, and generating electricity using the electrical submersible generator. The method further includes injecting the fluid into a second subterranean formation at a second zone of the well.

In another implementation, a system includes a well intersecting a first subterranean formation and a second subterranean formation. The system further includes an electrical submersible generator installed in the well, and a packer coupled to the electrical submersible generator. The packer is located between the first and second subterranean formations, and seals against a casing string of the well. The electrical submersible generator is configured to generate electricity when a fluid flows in the well from the first subterranean formation to the second subterranean formation. The electrical submersible generator is further configured to pump the fluid from the second subterranean formation to the first subterranean formation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 schematically illustrates a power system during a first operational phase.

FIG. 2 schematically illustrates a portion of the power system of FIG. 1 during a second operational phase.

FIGS. 3A and 3B schematically illustrate process flows for multiple wells that may be used with the power system of FIG. 1, in some embodiments.

FIGS. 4A and 4B schematically illustrate a power system.

FIGS. 5A and 5B schematically illustrate a power system.

FIG. 6 schematically illustrates a power system.

FIG. 7 schematically illustrates process flows for a single well that may be used with the power system of FIG. 6, in some embodiments.

FIG. 8 is a flow diagram of a method of operating a power system.

FIG. 9 is a flow diagram of a method of operating a power system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns power systems and processes, such for geothermal power systems. Embodiments relate particularly to the recovery of pressure energy and geothermal heat energy to perform useful work, such as generating electricity.

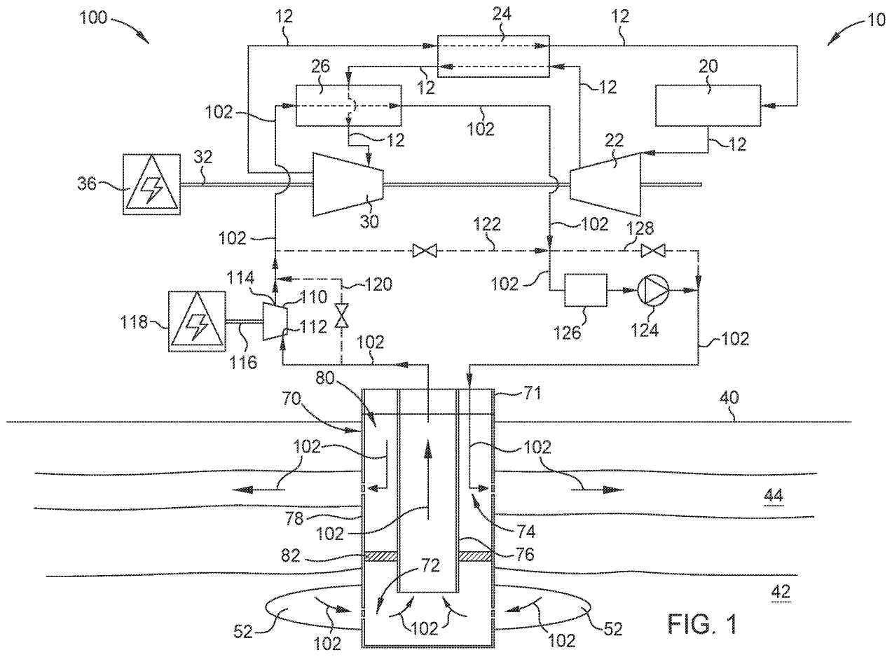

FIG. 1 schematically illustrates a power system 100 during a first operational phase. As illustrated, in some embodiments, the power system 100 includes a binary cycle power plant 10. In some embodiments, operation of the binary cycle power plant 10 is based on the Brayton Cycle. In some embodiments, operation of the binary cycle power plant 10 is based on the Rankine Cycle. In some embodiments, operation of the binary cycle power plant 10 is based on the Organic Rankine Cycle.

The binary cycle power plant 10 utilizes a working fluid (represented by arrows 12), such as water, steam, brine, a refrigerant, a supercritical fluid, carbon dioxide, ammonia, an organic compound (e.g., a hydrocarbon, a fluorocarbon, etc.), or any combination thereof. The working fluid 12 flows from a condenser 20 to a pressure booster 22, such as a pump (e.g. a single phase pump, a multi-phase pump, a centrifugal pump, or a positive displacement pump), a compressor, or the like. The pressure booster 22 increases the pressure of the working fluid 12, and moves the working fluid 12 through a recuperator 24 to a heat exchanger 26, where the working fluid 12 is heated. Exemplary types of heat exchanger 26 include concurrent flow, counter-flow, shell and tube, paraflow plate, and the like.

The heated working fluid 12 then flows to an expander 30, such as a turbine, a turbo-expander, or the like. The working fluid 12 drives the expander 30 to rotate a shaft 32. The shaft 32 is coupled to a generator 36. In an example, the shaft 32 is coupled to the generator 36 via a gearbox. The shaft 32 drives the generator 36 to produce electricity. The working fluid 12 loses pressure in driving the expander 30, and a temperature of the working fluid 12 drops. The working fluid 12 exits the expander 30, and passes through the recuperator 24, and back to the condenser 20.

In some embodiments, the pressure booster 22 and the expander 30 are coupled to a common shaft, such as shaft 32. In an example, the pressure booster 22 and the expander 30 are coupled to a common shaft via one or more gearboxes. In some embodiments, the pressure booster 22, the expander 30, and the generator 36 are coupled to a common shaft, such as shaft 32. In an example, the pressure booster 22, the expander 30, and the generator 36 are coupled to a common shaft via one or more gearboxes.

The power system 100 utilizes a power fluid (represented by arrows 102). The power fluid 102 may include any fluid (such as water, steam, brine, a refrigerant, a supercritical fluid, carbon dioxide, ammonia, an organic compound (e.g., a hydrocarbon, a fluorocarbon, etc.), or any combination thereof) that is injected into, or produced out of, a first subterranean formation 42. In some embodiments, the power fluid 102 is a geothermal fluid. In some embodiments, the first subterranean formation 42 is a geothermal subterranean formation.

The power fluid 102 may be heated, or may be maintained at an elevated temperature, by the first subterranean formation 42. In an example, the temperature of the power fluid 102 is at or about 150 degrees C. or higher, such as 175 degrees C. or higher, 200 degrees C. or higher, 250 degrees C. or higher, or 300 degrees C. or higher. The power fluid 102 is maintained at an elevated pressure in the first subterranean formation 42. In an example, the pressure of the power fluid 102 in the first subterranean formation 42 is at or about 3 MPa or higher, such as 5 MPa or higher, 10 MPa or higher, 20 MPa or higher, 30 MPa or higher, 40 MPa or higher, or 50 MPa or higher. In some embodiments, the power fluid 102 is geopressured. In an example, the power fluid 102 may be a geopressured-geothermal fluid.

The power fluid 102 flows from the first subterranean formation 42 into a well 70. In some embodiments, the power fluid 102 flows from the first subterranean formation 42 into the well 70 via one or more fractures 52 in the first subterranean formation 42 at the well 70. The well 70 includes a tubing string 76 installed inside a casing string 78. A packer 82 seals an annulus 80 between the tubing string 76 and the casing string 78. The power fluid 102 in the first subterranean formation 42 enters the well 70 at a first zone 72 below the packer 82, and flows up the tubing string 76 to a wellhead 71 of the well 70.

The power fluid 102 flows from the wellhead 71 to one or more turbines 110. In some embodiments, the one or more turbines 110 are Pelton Turbines. In some embodiments, the one or more turbines 110 are other types of turbine, such as Francis Turbines or Kaplan Turbines. In some embodiments, the one or more turbines 110 are located at the earth's surface 40. In some embodiments, the one or more turbines 110 are arranged in a series configuration such that the power fluid 102 flows to a first turbine 110 and then to a second turbine 110. In some embodiments, the one or more turbines 110 are arranged in a parallel configuration. In an example, a first portion of the power fluid 102 flows to a first turbine 110, and a different second portion of the power fluid 102 flows simultaneously to a second turbine 110. In another example, one of the first or second turbines 110 is offline (such as for maintenance), and the power fluid 102 flows to the other of the first or second turbines 110.

Each of the one or more turbines 110 is coupled to a shaft 116. Each shaft 116 is coupled to a corresponding generator 118. In an example, each shaft 116 is coupled to the corresponding generator 118 via a gearbox. Each shaft 116 drives the corresponding generator 118 to produce electricity.

Each of the one or more turbines 110 has an inlet 112 and an outlet 114. The power fluid 102 flows from the inlet 112, and through the turbine 110 to the outlet 114. A pressure of the power fluid 102 at the inlet 112 of each of the one or more turbines 110 is greater than the pressure of the power fluid 102 at the outlet 114 of each of the one or more turbines 110. The power fluid 102 experiences a drop in pressure from the inlet 112 to the outlet 114 of each turbine 110 as the power fluid 102 drives each turbine 110 to rotate the corresponding shaft 116, and drive the corresponding generator 118 to produce electricity. In an example, the pressure of the power fluid 102 at the outlet 114 of each turbine 110 is at or about 1 MPa or less, such as 0.5 MPa or less, 0.4 MPa or less, 0.3 MPa or less, or 0.2 MPa or less.

The power fluid 102 flows from the outlet 114 of each of the one or more turbines 110 to the heat exchanger 26. In some embodiments, the temperature of the power fluid 102 entering the heat exchanger 26 is similar to the temperature of the power fluid 102 at the wellhead 71 of the well 70. Heat is transferred from the power fluid 102 to the working fluid 12 as the power fluid 102 flows through the heat exchanger 26. In an example, the temperature of the power fluid 102 upon exiting the heat exchanger 26 is at or about 100 degrees C. or less, such as 90 degrees C. or less, 80 degrees C. or less, 70 degrees C. or less, 60 degrees C. or less, or 50 degrees C. or less.

The power fluid 102 flows from the heat exchanger 26 to one or more pumps 124. Exemplary pumps 124 include single phase pumps, multi-phase pumps, centrifugal pumps, positive displacement pumps, or the like. In some embodiments, the power fluid 102 flows from the heat exchanger 26 to a tank 126 (such as a suction tank, header tank, buffer tank, or the like) before flowing to the one or more pumps 124. In some embodiments, the tank 126 is omitted or bypassed. The one or more pumps 124 increase a pressure of the power fluid 102, and inject the power fluid 102 into the annulus 80 of the well 70 via the wellhead 71. In some embodiments, each of the one or more pumps 124 is coupled to a corresponding turbine 110 of the one or more turbines 110. In an example, each pump 124 may be driven at least in part by a corresponding turbine 110 via a common shaft. In another example, each pump 124 may be driven at least in part by a corresponding turbine 110 via one or more gearboxes. In some embodiments, the one or more pumps 124 are operated at an efficiency of 90% or above, such as 92% or above, or 95% or above.

The power fluid 102 in the annulus 80 of the well 70 exits the well 70 at a second zone 74 above the packer 82, and enters a second subterranean formation 44. The packer 82 is located between the first zone 72 and the second zone 74, and prevents fluid communication between the first zone 72 and the second zone 74 within the annulus 80.

The second subterranean formation 44 is different from the first subterranean formation 42. In an example, the second subterranean formation 44 is separated from the first subterranean formation 42 by other geological layers. In some embodiments, the second subterranean formation 44 is at a relatively shallow depth below the earth's surface 40 compared with a depth of the first subterranean formation 42. For example, the depth of the second subterranean formation 44 below the earth's surface 40 may be up to about 1,500 metres, such as up to about 1,250 metres, up to about 1,000 metres, up to about 750 metres, or up to about 500 metres. In contrast, for example, the depth of the first subterranean formation 42 below the earth's surface 40 may be up to about 5,000 metres, such as up to about 4,500 metres, up to about 4,000 metres, up to about 3,500 metres, or up to about 3,000 metres.

The fluid in the second subterranean formation 44 is at a relatively lower pressure compared to the pressure of the power fluid 102 in the first subterranean formation 42. For example, the pressure of the fluid in the second subterranean formation 44 may be up to about 15 MPa, such as up to about 12.5 MPa, up to about 10 MPa, up to about 7.5 MPa, or up to about 5 MPa.

In some embodiments, each turbine 110 is operated such that the pressure of the power fluid 102 at the outlet 114 of each turbine 110 is high enough to inject the power fluid 102 into the second subterranean formation 44 without using the one or more pumps 124. In an example, the pressure of the power fluid 102 at the outlet 114 of each turbine 110 is at or about 10 MPa or greater, such as 15 MPa or greater, 20 MPa or greater, 25 MPa or greater, or 30 MPa or greater. In some embodiments, flow of the power fluid 102 may bypass the one or more pumps 124 (represented by dashed line 128).

In some embodiments, the one or more turbines 110 are omitted. In some embodiments, flow of the power fluid 102 may bypass the one or more turbines 110 (represented by dashed line 120). In some embodiments, the binary cycle power plant 10 is omitted. In some embodiments, flow of at least a portion of the power fluid 102 may bypass the binary cycle power plant 10. The bypass being represented by dashed line 122.

In some embodiments, the well 70 is operated such that the one or more fractures 52 remain open while the power fluid 102 is produced from the first subterranean formation 42 into the well 70. In an example, a pressure of the power fluid 102 within the one or more fractures 52 is maintained at a magnitude that is greater than a closure pressure of the one or more fractures 52. In another example, a pressure of the power fluid 102 within the one or more fractures 52 is maintained at a magnitude that is greater than an opening pressure of the one or more fractures 52. In another example, a pressure of the power fluid 102 within the one or more fractures 52 is maintained at a magnitude that is between the opening pressure and the closure pressure of the one or more fractures 52. In another example, a pressure of the power fluid 102 within the one or more fractures 52 is maintained at a magnitude that is greater than a reopening pressure of the one or more fractures 52. In another example, a pressure of the power fluid 102 within the one or more fractures 52 is maintained at a magnitude that is between the reopening pressure and the closure pressure of the one or more fractures 52.

In some embodiments, operation of the well 70 such that the one or more fractures 52 remain open is performed by regulating a pressure within the well 70 by a control valve, such as a choke, at the wellhead 71. In some embodiments, operation of the well 70 such that the one or more fractures 52 remain open is performed by regulating a pressure within the well 70 by controlling the operation of the one or more turbines 110. In an example, the pressure drop experienced by the power fluid 102 flowing through the one or more turbines 110 creates a back-pressure on the power fluid 102 exiting the well 70.

In some embodiments, operation of a control valve is omitted when regulating a pressure within the well 70 by controlling the operation of the one or more turbines 110.

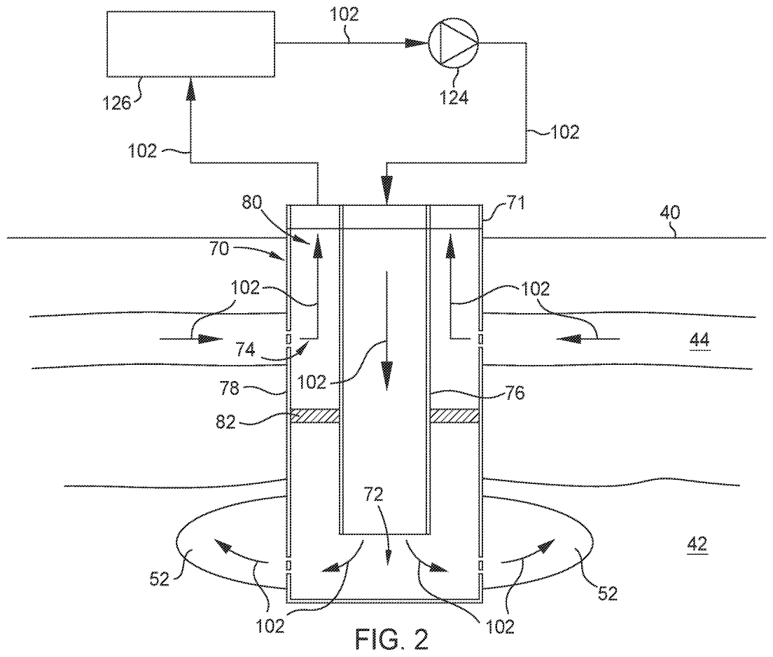

FIG. 2 schematically illustrates a portion of the power system 100 during a second operational phase subsequent to the first operational phase. Flow of the power fluid 102 into the well from the first subterranean formation 42 is ceased. Flow of the power fluid 102 into the second subterranean formation 44 is ceased. Then, the power fluid 102 in the second subterranean formation 44 is produced back into the well at the second zone 74. The power fluid 102 flows up the annulus 80 to the wellhead 71. An intake of the one or more pumps 124 is fluidically coupled to the annulus 80 via the wellhead 71, such as via an annulus wing valve of the wellhead 71. The power fluid 102 flows to the one or more pumps 124. In some embodiments, the power fluid 102 flows into the tank 126 upstream of the one or more pumps 124. In some embodiments, the tank 126 is omitted or is bypassed, such as via the bypass 128.

A discharge of the one or more pumps 124 is fluidically coupled to the tubing string 76 of the well 70 via the wellhead 71, such as via a wing valve of the wellhead 71. The one or more pumps 124 pump the power fluid 102 into the tubing string 76 of the well 70. The power fluid 102 flows through the tubing string 76, and enters the first subterranean formation 42 at the first zone 72 of the well 70. The power fluid 102 flows from the well 70 into the first subterranean formation 42 via the one or more fractures 52 in the first subterranean formation 42.

In some embodiments, the well 70 is operated such that the one or more fractures 52 remain open while the power fluid 102 is injected into the first subterranean formation 42 from the well 70. In an example, a pressure of the power fluid 102 within the one or more fractures 52 is maintained at a magnitude that is greater than a closure pressure of the one or more fractures 52. In another example, a pressure of the power fluid 102 within the one or more fractures 52 is maintained at a magnitude that is greater than an opening pressure of the one or more fractures 52. In another example, a pressure of the power fluid 102 within the one or more fractures 52 is maintained at a magnitude that is between the opening pressure and the closure pressure of the one or more fractures 52. In another example, a pressure of the power fluid 102 within the one or more fractures 52 is maintained at a magnitude that is greater than a reopening pressure of the one or more fractures 52. In another example, a pressure of the power fluid 102 within the one or more fractures 52 is maintained at a magnitude that is between the reopening pressure and the closure pressure of the one or more fractures 52.

In some embodiments, operation of the well 70 such that the one or more fractures 52 remain open is performed by regulating the one or more pumps 124.

The power fluid 102 is heated by the first subterranean formation 42. The first and second phases of operation of the power system 100 are then repeated. In some embodiments, the power system 100 continues to operate to generate electricity while the power fluid 102 is being transferred from the second subterranean formation 44 to the first subterranean formation 42 at the well 70. In an example, the power system 100 receives additional power fluid 102 produced from the first subterranean formation 42 via an additional well. The additional power fluid 102 produced via the additional well is then injected into the second subterranean formation 44 at the additional well using the one or more pumps 124. Meanwhile, one or more additional pumps transfer the power fluid 102 originally produced via the well 70 from the second subterranean formation 44 to the first subterranean formation 42 at the well 70.

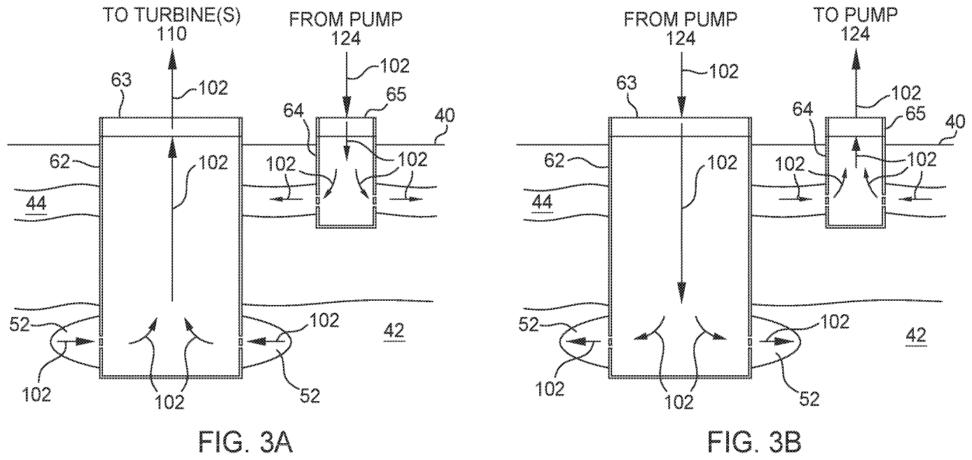

FIGS. 3A and 3B schematically illustrate the flow of the power fluid 102 using multiple wells in some embodiments. FIG. 3A shows the operation of a first well 62 and a second well 64 during the first phase of operation of the power system 100. The power fluid 102 is produced from the first subterranean formation 42 at a first well 62, and is injected into the second subterranean formation 44 at a second well 64. The power fluid 102 enters the first well 62 from the first subterranean formation 42, and flows up to a wellhead 63 of the first well 62. Components of the power system 100, such as the one or more turbines 110 or the heat exchanger 26, are fluidically coupled to the wellhead 63. The power fluid 102 flows through the power system 100, which uses the power fluid 102 to produce electricity, as described above. Components of the power system 100, such as the one or more pumps 124 or the bypass 128, are fluidically coupled to a wellhead 65 of the second well 64. The power fluid 102 flows from the one or more pumps 124 or the bypass 128 to the second well 64 via the wellhead 65. The power fluid 102 flows through the second well 64, and into the second subterranean formation 44.

FIG. 3B shows the operation of the first well 62 and the second well 64 during the second phase of operation of the power system 100. An intake of the one or more pumps 124 is fluidically coupled to the second well 64 via the wellhead 65. A discharge of the one or more pumps 124 is fluidically coupled to the first well 62 via the wellhead 63. The power fluid 102 is produced from the second subterranean formation 44 at the second well 64, and is injected into the first subterranean formation 42 at the first well 62 by the one or more pumps 124.

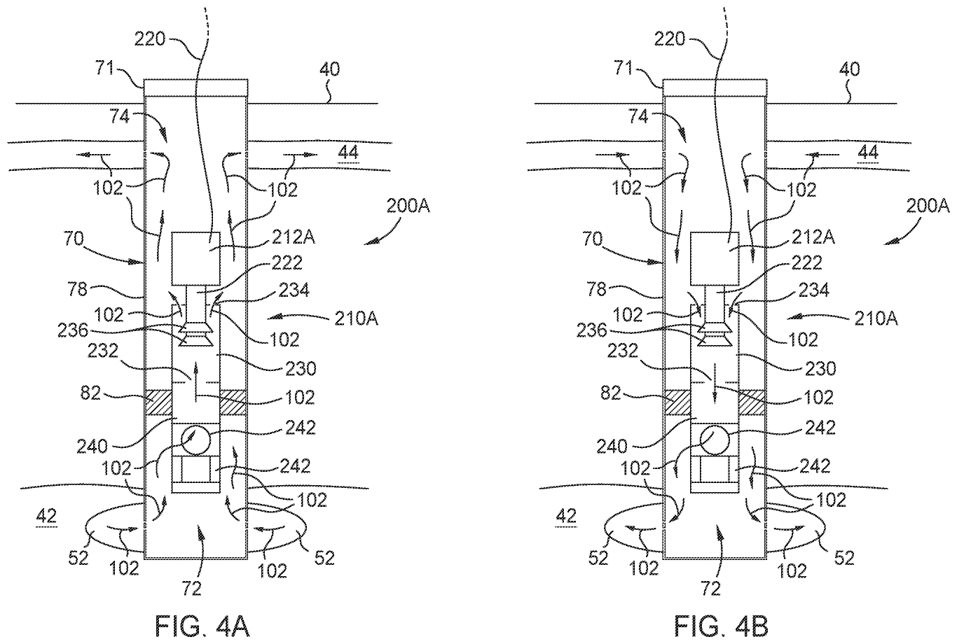

FIGS. 4A and 4B schematically illustrate a power system 200A. The power system 200A utilizes the power fluid 102, described above. The pressure and temperature of the power fluid 102 in the first subterranean formation 42 and at various portions of the power system 200A may be similar to the pressure and temperature of the power fluid 102 in the first subterranean formation 42 and at equivalent portions of the power system 100, described above.

The power system 200A includes an electrical submersible generator 210A that is installed in the well 70. The electrical submersible generator 210A is configured to operate as a pump and as an electrical power generator. An exemplary electrical submersible generator 210A is an electrical submersible pump in which impellers of a typical pump section are adapted to be driven by fluid flow. In an example, the impellers may be adapted as disclosed in Risa Rutter, et al., Numerical Simulation and Design Optimization of an Electrical Submersible Power Recovery Turbine, Proceedings of ASME Turbo Expo 2019, GT2019-90643 (Jun. 17-21, 2019, Phoenix, Arizona, USA); or Charles Collins, et al., Electric Submersible Generators—Using ESPs in an Unfamiliar Way, SPE-214361-MS, presented at the SPE EuropEC—Europe Energy Conference featured at the 84^{th} EAGE Annual Conference & Exhibition (Vienna, Austria, 5-8 Jun. 2023); all of which are incorporated herein by reference.

The electrical submersible generator 210A includes a motor 212A coupled to an impeller section 230 by a shaft 222. The motor 212A is coupled to a power source (such as a power grid, battery, or the like) at the earth's surface 40 by a power cable 220. In a first mode of operation, the motor 212A receives electrical power from the power source via the power cable 220, and drives one or more impellers 236 of the impeller section 230 by rotating the shaft 222. The one or more impellers 236 push fluid through the impeller section 230, and the electrical submersible generator 210A operates as a pump. In a second mode of operation, a flow of fluid through the impeller section 230 drives the one or more impellers 236 to rotate the shaft 222. Rotation of the shaft 222 drives the motor 212A, which generates electricity, and the electrical submersible generator 210A operates as a generator. The electricity generated by the motor 212A is communicated to a power grid, battery, or the like at the surface via the power cable 220.

The impeller section 230 is coupled to the packer 82. In some embodiments, the impeller section 230 is coupled to a tail pipe 240. The packer 82 provides a seal between the impeller section 230 and/or tail pipe 240 and the casing string 78 of the well 70. In some embodiments, a valve 242 (such as a sliding sleeve, a ball valve, or the like) in the tail pipe 240 is adjusted between open and closed positions to selectively allow or prevent passage of fluids through the tail pipe 240. In some embodiments, the valve 242 is operated by command signals communicated via the power cable 220. In some embodiments, the valve 242 is omitted.

In some embodiments, one or more gauges 244 in the tail pipe 240 monitor the pressure and temperature of fluid in the tail pipe 240 or at the first zone 72 of the well 70. In some embodiments, the one or more gauges 244 communicate pressure and temperature readings to a controller at the earth's surface 40 via the power cable 220. In some embodiments, the one or more gauges 244 are omitted.

FIG. 4A schematically illustrates the electrical submersible generator 210A operating as a generator. A pressure difference exists between the pressure of the power fluid 102 in the first subterranean formation 42 and the pressure of fluid in second subterranean formation 44 plus the hydrostatic head of fluid between the second subterranean formation 44 and the first subterranean formation 42. The pressure of the power fluid 102 in the first subterranean formation 42 is greater than the pressure of fluid in the second subterranean formation 44 plus the hydrostatic head of fluid between the second subterranean formation 44 and the first subterranean formation 42.

The valve 242 is opened, and the power fluid 102 in the subterranean formation is exposed to the pressure difference described above. Under the influence of the pressure difference, the power fluid 102 flows from the first subterranean formation 42 into the well 70, as described above. The power fluid 102 in the first subterranean formation 42 enters the well 70 at the first zone 72 below the packer 82, and flows into the tail pipe 240 via the valve 242.

The power fluid 102 flows into the impeller section 230 of the electrical submersible generator 210A via a first port 232. The power fluid 102 passes through the impeller section 230. The power fluid 102 drives the one or more impellers 236 in the impeller section 230 to rotate the shaft 222. Rotation of the shaft 222 causes the motor 212A coupled to the shaft 222 to generate electricity. The electricity is communicated to the power grid, battery, or the like at the earth's surface 40 via the power cable 220.

The power fluid 102 exits the impeller section 230 via a second port 234, and travels through the well 70 to the second zone 74. The power fluid 102 exits the well 70 at the second zone 74 above the packer 82, and enters the second subterranean formation 44. In some embodiments, the valve 242 is closed after a predetermined time of flowing the power fluid 102 from the first subterranean formation 42 to the second subterranean formation 44. In some embodiments, the valve 242 is closed if a flow rate of the power fluid 102 declines beyond a threshold value. In some embodiments, the valve 242 is closed if the electrical power generated by the motor 212A declines beyond a threshold value. In some embodiments, the valve 242 is closed if the pressure measured by the one or more gauges 244 declines beyond a threshold value. In some embodiments, the valve 242 remains open after flowing the power fluid 102 from the first subterranean formation 42 to the second subterranean formation 44.

FIG. 4B schematically illustrates the electrical submersible generator 210A operating as a pump. In embodiments in which the valve 242 is closed after flowing the power fluid 102 from the first subterranean formation 42 to the second subterranean formation 44, the valve 242 is opened to restore fluidic communication between the first subterranean formation 42 and the second subterranean formation 44.

The motor 212A receives electrical power from the power source via the power cable 220, and rotates the shaft 222. Rotation of the shaft 222 drives the one or more impellers 236 of the impeller section 230. The one or more impellers 236 propel the power fluid 102 through the impeller section 230 and into the tail pipe 240. The electrical submersible generator 210A acts as a pump, pumping the geothermal fluid from the second subterranean formation 44 into the first subterranean formation 42. The power fluid 102 in the second subterranean formation 44 flows into the well 70 at the second zone 74, and passes down the well to the electrical submersible generator 210A. The power fluid 102 flows into the impeller section 230 of the electrical submersible generator 210A via the second port 234, and exits the impeller section 230 via the first port 232. The power fluid 102 flows through the tail pipe 240, and through the valve 242 into the first zone 72. The power fluid 102 enters the first subterranean formation 42 at the first zone 72.

In some embodiments, the valve 242 is closed after a predetermined time of flowing the power fluid 102 from the second subterranean formation 44 to the first subterranean formation 42. In some embodiments, the valve 242 is closed if a flow rate of the power fluid 102 declines beyond a threshold value. In some embodiments, the valve 242 is closed if the electrical power demand of the motor 212A increases beyond a threshold value. In some embodiments, the valve 242 is closed if the pressure measured by the one or more gauges 244 increases beyond a threshold value.

The power system 200A is operated in a repeating sequence in which the electrical submersible generator 210A is operated as a generator and then operated as a pump. Operating the electrical submersible generator 210A as a generator may be during periods of high demand for electricity, or periods during which one or more other sources of electricity are offline. Operating the electrical submersible generator 210A as a pump may be during periods in which there is excess capacity of electrical power available for use.

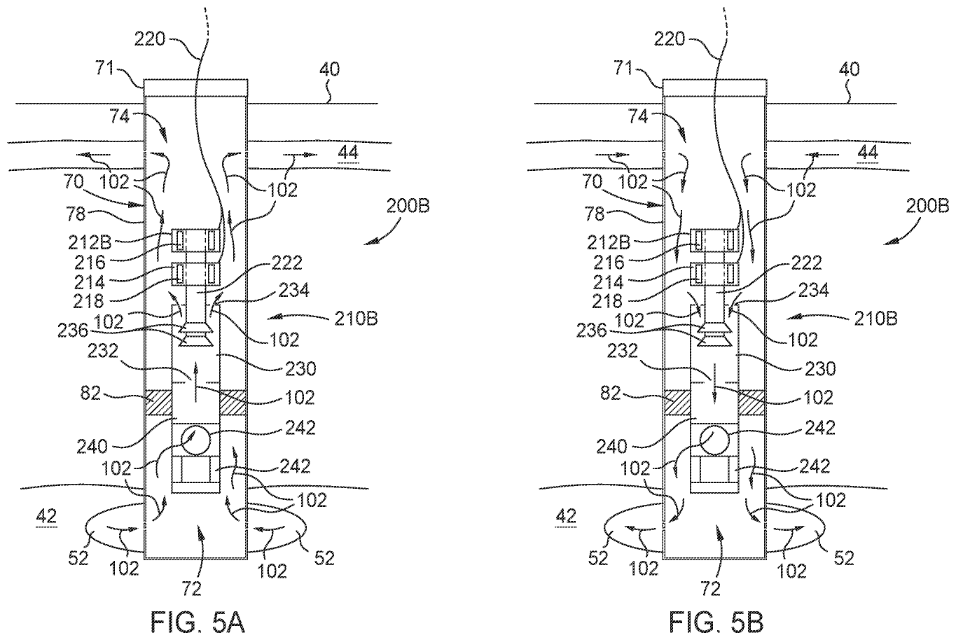

FIGS. 5A and 5B schematically illustrate a power system 200B. The power system 200B utilizes the power fluid 102, described above. The pressure and temperature of the power fluid 102 in the first subterranean formation 42 and at various portions of the power system 200B may be similar to the pressure and temperature of the power fluid 102 in the first subterranean formation 42 and at equivalent portions of the power system 100, described above.

The power system 200B includes an electrical submersible generator 210B that is installed in the well 70. The electrical submersible generator 210B is configured to operate as a pump and as a power generator, and is similar to the electrical submersible generator 210A of power system 200A. The electrical submersible generator 210B includes the impeller section 230 of the electrical submersible generator 210A.

In the electrical submersible generator 210B, the motor 212A of electrical submersible generator 210A is replaced by a motor 212B and a generator. In some embodiments, the motor 212B is the same as the motor 212A. The motor 212B and the generator are coupled to the shaft 222. In some embodiments, the motor 212B is coupled to the shaft 222 by a clutch 21. The clutch 216 facilitates selective coupling and decoupling of the motor 212B and the shaft 222. In some embodiments, the clutch 216 is omitted. In some embodiments, the generator is coupled to the shaft 222 by a clutch 218. The clutch 218 facilitates selective coupling and decoupling of the generator and the shaft 222. In some embodiments, the clutch 218 is omitted.

The motor 212B is coupled to the power source at the earth's surface 40 by the power cable 220. In some embodiments, the power cable 220 couples the generator to the power grid, battery, or the like at the earth's surface 40. In some embodiments, a second power cable couples the generator to the power grid, battery, or the like at the earth's surface 40.

The impeller section 230 is coupled to the packer 82. In some embodiments, the impeller section 230 is coupled to the tail pipe 240. The packer 82 provides a seal between the impeller section 230 and/or tail pipe 240 and the casing string 78 of the well 70. In some embodiments, the valve 242 (described above) is installed in the tail pipe 240. In some embodiments, the valve 242 is omitted. In some embodiments, the one or more gauges 244 (described above) are installed in the tail pipe 240. In some embodiments, the one or more gauges 244 are omitted.

FIG. 5A schematically illustrates the electrical submersible generator 210B operating as a generator. The flow of the power fluid 102 and the operation of the electrical submersible generator 210B as a generator is similar to the operation of electrical submersible generator 210A described above with respect to FIG. 4A. When the electrical submersible generator 210B operates as a generator, the generator is coupled to the shaft 222, such as via the clutch 218. In some embodiments, the motor 212B is coupled to the shaft 222, such as via the clutch 216. In some embodiments, the clutch 216 decouples the motor 212B from the shaft 222.

The flow of the power fluid 102 from the first subterranean formation 42 to the second subterranean formation 44 through the impeller section 230 causes rotation of the shaft 222, which drives the generator to produce electricity. The electricity is communicated to the power grid, battery, or the like at the earth's surface 40 via the power cable 220 (or a second power cable).

In some embodiments, the valve 242 is closed after a predetermined time of flowing the power fluid 102 from the first subterranean formation 42 to the second subterranean formation 44. In some embodiments, the valve 242 is closed if a flow rate of the power fluid 102 declines beyond a threshold value. In some embodiments, the valve 242 is closed if the electrical power generated by the motor 212B declines beyond a threshold value. In some embodiments, the valve 242 is closed if the pressure measured by the one or more gauges 244 declines beyond a threshold value. In some embodiments, the valve 242 remains open after flowing the power fluid 102 from the first subterranean formation 42 to the second subterranean formation 44.

FIG. 5B schematically illustrates the electrical submersible generator 210B operating as a pump. The flow of the power fluid 102 and the operation of the electrical submersible generator 210B as a pump is similar to the operation of electrical submersible generator 210A described above with respect to FIG. 4B. When the electrical submersible generator 210B operates as a pump, the motor 212B is coupled to the shaft 222, such as via the clutch 216. In some embodiments, the generator is coupled to the shaft 222, such as via the clutch 218. In some embodiments, the clutch 218 decouples the generator from the shaft 222.

In embodiments in which the valve 242 is closed after flowing the power fluid 102 from the first subterranean formation 42 to the second subterranean formation 44, the valve 242 is opened to restore fluidic communication between the first subterranean formation 42 and the second subterranean formation 44.

The motor 212B receives electrical power from the power source via the power cable 220, and rotates the shaft 222. Rotation of the shaft 222 drives the one or more impellers 236 of the impeller section 230. The one or more impellers 236 propel the power fluid 102 through the impeller section 230 and into the tail pipe 240. The electrical submersible generator 210B acts as a pump, pumping the geothermal fluid from the second subterranean formation 44 into the first subterranean formation 42, as described above with respect to FIG. 4B.

In some embodiments, the valve 242 is closed after a predetermined time of flowing the power fluid 102 from the second subterranean formation 44 to the first subterranean formation 42. In some embodiments, the valve 242 is closed if a flow rate of the power fluid 102 declines beyond a threshold value. In some embodiments, the valve 242 is closed if the electrical power demand of the motor 212B increases beyond a threshold value. In some embodiments, the valve 242 is closed if the pressure measured by the one or more gauges 244 increases beyond a threshold value.

The power system 200B is operated in a repeating sequence in which the electrical submersible generator 210B is operated as a generator and then operated as a pump. Operating the electrical submersible generator 210B as a generator may be during periods of high demand for electricity, or periods during which one or more other sources of electricity are offline. Operating the electrical submersible generator 210B as a pump may be during periods in which there is excess capacity of electrical power available for use.

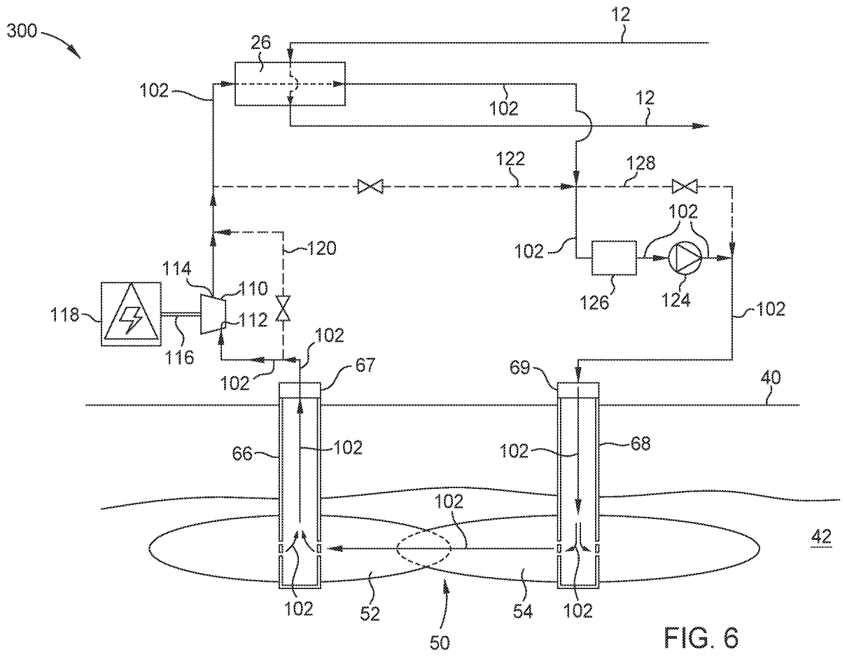

FIG. 6 schematically illustrates a power system 300. In some embodiments, the power system 300 includes the one or more turbines 110, the corresponding shafts 116, and the corresponding generators 118 of the power system 100. In some embodiments, the power system 300 includes the provision 120 to bypass the one or more turbines 110. In some embodiments, the power system 300 includes the one or more pumps 124 of the power system 100. In some embodiments, the power system 300 includes the provision 128 to bypass the one or more pumps 124.

The power system 300 utilizes the power fluid 102, described above. The pressure and temperature of the power fluid 102 in the first subterranean formation 42 and at various portions of the power system 300 may be similar to the pressure and temperature of the power fluid 102 in the first subterranean formation 42 and at equivalent portions of the power system 100, described above.

The power fluid 102 flows from the first subterranean formation 42 into a production well 66. In some embodiments, the power fluid 102 flows from the first subterranean formation 42 into the production well 66 via one or more fractures 52 in the first subterranean formation 42 at the production well 66. The power fluid 102 flows through the production well 66 to a wellhead 67 of the production well 66.

In some embodiments, the power fluid 102 flows from the wellhead 67 to the one or more turbines 110, as described above. The power fluid 102 drives each turbine 110 to rotate each corresponding shaft 116, and drive each corresponding generator 118 to produce electricity, as described above. In some embodiments, the one or more turbines 110 are omitted. In some embodiments, flow of the power fluid 102 may bypass the one or more turbines 110 (represented by dashed line 120).

In some embodiments, the power fluid 102 flows from the one or more turbines 110 or from the bypass 120 to the heat exchanger 26, described above. In some embodiments, the temperature of the power fluid 102 entering the heat exchanger 26 is similar to the temperature of the power fluid 102 at the wellhead 67 of the production well 66. The heat exchanger 26 receives also the working fluid 12, described above. Heat is transferred from the power fluid 102 to the working fluid 12 as the power fluid 102 flows through the heat exchanger 26.

The heated working fluid 12 exits the heat exchanger 26, and proceeds to one or more direct use applications. An exemplary direct use application of the heated working fluid 12 is to provide heat to a building.

In some embodiments, at least a portion of the power fluid 102 bypasses the heat exchanger 26, such as via bypass 122. The power fluid 102 flows from the heat exchanger 26 and/or the bypass 122 to the one or more pumps 124, as described above. In some embodiments, the power fluid 102 flows from the heat exchanger 26 to the tank 126 (as described above) before flowing to the one or more pumps 124. In some embodiments, the tank 126 is omitted or bypassed. The one or more pumps 124 increase a pressure of the power fluid 102, and inject the power fluid 102 into an injection well 68 via a wellhead 69 of the injection well 68. In some embodiments, each of the one or more pumps 124 is coupled to a corresponding turbine 110 of the one or more turbines 110. Each pump 124 may be driven at least in part by a corresponding turbine 110, such as via a common shaft. In some embodiments, the one or more pumps 124 are operated at an efficiency of 90% or above, such as 92% or above, or 95% or above.

The power fluid 102 flows from the injection well 68 into the first subterranean formation 42. In some embodiments, the power fluid 102 flows from the injection well 68 into the first subterranean formation 42 via one or more fractures 54 in the first subterranean formation 42. The power fluid 102 flows in the first subterranean formation 42 from the injection well 68 towards the production well 66. The power fluid 102 is heated by the first subterranean formation 42. In some embodiments, the producing of the power fluid 102 from the first subterranean formation 42 via the production well 66, and the injecting of the power fluid 102 into the first subterranean formation 42 at the injection well 68 are performed simultaneously.

A fracture network 50 in the first subterranean formation 42 includes the one or more fractures 54 and the one or more fractures 52. In some embodiments, the one or more factures 54 intersect with one or more of the one or more fractures 52. In some embodiments, the one or more factures 54 are contiguous with one or more of the one or more fractures 52. Maintaining the one or more fractures 54 and the one or more fractures 52 of the fracture network 50 in an open condition while producing the power fluid 102 and while injecting the power fluid 102 facilitates effective heating of the power fluid 102 by the first subterranean formation 42.

In some embodiments, the production well 66 is operated such that the one or more fractures 52 remain open while the power fluid 102 is produced from the first subterranean formation 42 into the production well 66. In an example, a pressure of the power fluid 102 within the one or more fractures 52 is maintained at a magnitude that is greater than a closure pressure of the one or more fractures 52. In another example, a pressure of the power fluid 102 within the one or more fractures 52 is maintained at a magnitude that is greater than an opening pressure of the one or more fractures 52. In another example, a pressure of the power fluid 102 within the one or more fractures 52 is maintained at a magnitude that is between the opening pressure and the closure pressure of the one or more fractures 52. In another example, a pressure of the power fluid 102 within the one or more fractures 52 is maintained at a magnitude that is greater than a reopening pressure of the one or more fractures 52. In another example, a pressure of the power fluid 102 within the one or more fractures 52 is maintained at a magnitude that is between the reopening pressure and the closure pressure of the one or more fractures 52.

In some embodiments, operation of the production well 66 such that the one or more fractures 52 remain open is performed by regulating a pressure within the production well 66 by a control valve, such as a choke. In some embodiments, operation of the production well 66 such that the one or more fractures 52 remain open is performed by regulating a pressure within the production well 66 by controlling the operation of the one or more turbines 110. In an example, the pressure drop experienced by the power fluid 102 flowing through the one or more turbines 110 creates a back-pressure on the power fluid 102 exiting the production well 66.

In some embodiments, operation of a control valve is omitted when regulating a pressure within the production well 66 by controlling the operation of the one or more turbines 110.

In some embodiments, the injection well 68 is operated such that the one or more fractures 54 remain open while the power fluid 102 is injected into the first subterranean formation 42 from the injection well 68. In an example, a pressure of the power fluid 102 within the one or more fractures 54 is maintained at a magnitude that is greater than a closure pressure of the one or more fractures 54. In another example, a pressure of the power fluid 102 within the one or more fractures 54 is maintained at a magnitude that is greater than an opening pressure of the one or more fractures 54. In another example, a pressure of the power fluid 102 within the one or more fractures 54 is maintained at a magnitude that is between the opening pressure and the closure pressure of the one or more fractures 54. In another example, a pressure of the power fluid 102 within the one or more fractures 54 is maintained at a magnitude that is greater than a reopening pressure of the one or more fractures 54. In another example, a pressure of the power fluid 102 within the one or more fractures 54 is maintained at a magnitude that is between the reopening pressure and the closure pressure of the one or more fractures 54.

In some embodiments, operation of the injection well 68 such that the one or more fractures 54 remain open is performed by regulating the one or more pumps 124.

In some embodiments, the power system 300 incorporates, or is coupled to, the well 70 (described above) instead of, or in addition to, the production well 66 and the injection well 68. In such embodiments, operation of the well 70 with the power system 300 is similar to operation of the well 70 with the power system 100, as described above.

In some embodiments, the power system 300 incorporates, or is coupled to, is coupled to the first well 62 and the second well 64 (described above) instead of, or in addition to, the production well 66 and the injection well 68. In such embodiments, operation of the first well 62 and the second well 64 with the power system 300 is similar to operation of the first well 62 and the second well 64 with the power system 100, as described above.

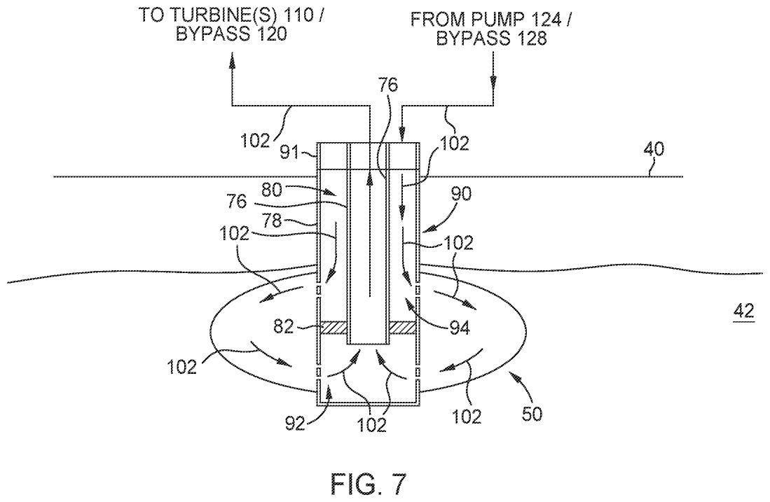

In some embodiments, the power system 300 is coupled to a well 90 instead of, or in addition to, the production well 66 and the injection well 68. The well 90 is schematically illustrated in FIG. 7.

The well 90 includes a production zone 92 and an injection zone 94. Fluids in the first subterranean formation 42 flow into the well 90 at the production zone 92. Fluids flow from the well 90 into the first subterranean formation 42 at the injection zone 94. The fracture network 50 in the first subterranean formation 42 is fluidically coupled to the production zone 92 and to the injection zone 94.

The well 90 includes the tubing string 76 installed inside the casing string 78. The packer 82 seals the annulus 80 between the tubing string 76 and the casing string 78. The packer 82 is located between the production zone 92 and the injection zone 94. The power fluid 102 in the first subterranean formation 42 enters the well 90 at the production zone 92, and flows up the tubing string 76 to a wellhead 91 of the well 90. The power fluid 102 flows from the wellhead 91 to the one or more turbines 110. Operation of the one or more turbines 110, the corresponding generators 120, the heat exchanger 26, and the one or more pumps 124 is as described above. The one or more pumps 124 inject the power fluid 102 into the annulus 80 of the well 90 via the wellhead 91. In some embodiments, the power fluid 102 flows to the wellhead 91 and into the annulus 80 via the bypass 128. The power fluid 102 exits the well 90 at the injection zone 94, and enters the first subterranean formation 42.

The power fluid 102 flows in the first subterranean formation 42 from the injection zone 94 of the well 90 towards the production zone 92 of the well 90. The power fluid 102 is heated by the first subterranean formation 42. In some embodiments, the producing of the power fluid 102 from the first subterranean formation 42 via the well 90, and the injecting of the power fluid 102 into the first subterranean formation 42 at the well 90 are performed simultaneously.

In some embodiments, the well 90 is operated such that the fracture network 50 remains open while the power fluid 102 is produced from the first subterranean formation 42 into the production zone 92. In some embodiments, the well 90 is operated such that the fracture network 50 remains open while the power fluid 102 is injected into the first subterranean formation 42 at the injection zone 94. In an example, a pressure of the power fluid 102 within the fracture network 50 is maintained at a magnitude that is greater than a closure pressure of one or more fractures of the fracture network 50. In another example, a pressure of the power fluid 102 within the fracture network 50 is maintained at a magnitude that is greater than an opening pressure of one or more fractures of the fracture network 50. In another example, a pressure of the power fluid 102 within the fracture network 50 is maintained at a magnitude that is between the opening pressure and the closure pressure of one or more fractures of the fracture network 50. In another example, a pressure of the power fluid 102 within the fracture network 50 is maintained at a magnitude that is greater than a reopening pressure of one or more fractures of the fracture network 50. In another example, a pressure of the power fluid 102 within the fracture network 50 is maintained at a magnitude that is between the reopening pressure and the closure pressure of one or more fractures of the fracture network 50.

In some embodiments, operation of the well 90 such that the fracture network 50 remains open is performed by regulating a pressure within the well 90 by a control valve, such as a choke. In some embodiments, operation of the well 90 such that fracture network 50 remains open is performed by regulating a pressure within the well 90 by controlling the operation of the one or more turbines 110. In an example, the pressure drop experienced by the power fluid 102 flowing through the one or more turbines 110 creates a back-pressure on the power fluid 102 exiting the well 90. In some embodiments, operation of a control valve is omitted when regulating a pressure within the well 90 by controlling the operation of the one or more turbines 110. In some embodiments, operation of the well 90 such that the fracture network 50 remains open is performed by regulating the one or more pumps 124.

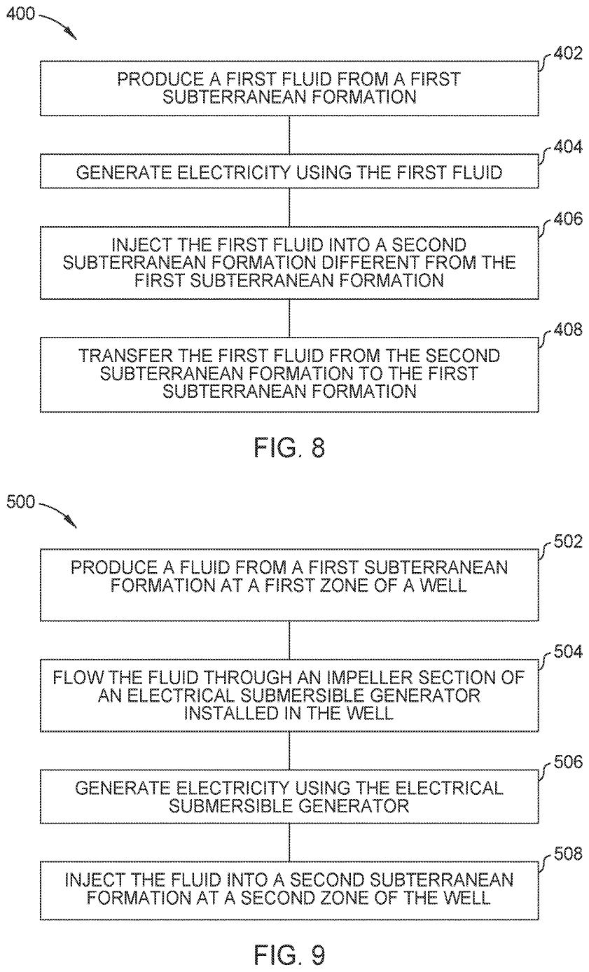

FIG. 8 is a flow diagram of a method 400 of operating a power system. The power system may be any of power system 100, 200A, 200B, or 300.

Operation 402 includes producing a first fluid from a first subterranean formation. In some embodiments, the first fluid is a geothermal fluid, such as power fluid 102. In some embodiments, the first subterranean formation is first subterranean formation 42.

Operation 404 includes generating electricity using the first fluid. In some embodiments, operation 404 includes flowing the first fluid through a turbine (such as turbine 110) coupled to a generator (such as generator 118). In some embodiments, operation 404 includes flowing the first fluid to a heat exchanger (such as heat exchanger 26). In some embodiments, operation 404 includes using heat of the first fluid to increase a temperature of a second fluid at the heat exchanger. In an example, the second fluid is a working fluid (such as working fluid 12) of a binary cycle power plant (such as binary cycle power plant 10). In some embodiments, operation 404 includes flowing the second fluid through an expander (such as expander 30) coupled to a generator (such as generator 36), and generating the electricity using the generator.

In some embodiments, operation 404 includes flowing the first fluid through an impeller section (such as impeller section 230) of an electrical submersible generator (such as electrical submersible generator 210A or 210B). In some embodiments, operation 404 includes using the first fluid to drive a motor (such as motor 212A or 212B) coupled to one or more impellers (such as impellers 236) of the impeller section. In some embodiments, operation 404 includes using the first fluid to drive a generator (such as generator 214) coupled to one or more impellers (such as impellers 236) of the impeller section. In some embodiments, the electrical submersible generator is installed in a well, such as well 70.

Operation 406 includes injecting the first fluid into a second subterranean formation different from the first subterranean formation. In some embodiments, operation 406 is performed after operation 404. In some embodiments, the second subterranean formation is the second subterranean formation 44. In some embodiments, operation 402 and operation 406 are performed in the same well. In some embodiments, operation 402 and operation 406 are performed in different wells.

Operation 408 includes transferring the first fluid from the second subterranean formation to the first subterranean formation. In some embodiments, operation 408 is performed after operation 406. In some embodiments in which an electrical submersible generator is installed in a well, operation 408 includes operating the electrical submersible generator as a pump.

FIG. 9 is a flow diagram of a method 500 of operating a power system. The power system may be power system 200A or 200B.

Operation 502 includes producing a fluid from a first subterranean formation at a first zone of a well. In some embodiments, the fluid is a geothermal fluid, such as power fluid 102. In some embodiments, the first subterranean formation is first subterranean formation 42. In some embodiments, the well is well 70.

Operation 504 includes flowing the fluid through an impeller section (such as impeller section 230) of an electrical submersible generator (such as electrical submersible generator 210A or 210B) installed in the well.

Operation 506 includes generating electricity using the electrical submersible generator. In some embodiments, operation 404 includes using the fluid to drive a motor (such as motor 212A or 212B) coupled to one or more impellers (such as impellers 236) of the impeller section. In some embodiments, operation 404 includes using the fluid to drive a generator (such as generator 214) coupled to one or more impellers (such as impellers 236) of the impeller section. In some of such embodiments, a motor (such as motor 212B) is decoupled from the one or more impellers while driving the generator using the one or more impellers. In some of such embodiments, a motor (such as motor 212B) is not decoupled from the one or more impellers while driving the generator using the one or more impellers.

Operation 508 includes injecting the fluid into a second subterranean formation at a second zone of the well. In some embodiments, operation 508 is performed after operation 506. In some embodiments, the second subterranean formation is different from the first subterranean formation. In some embodiments, the second subterranean formation is the second subterranean formation 44.

In some embodiments, method 500 includes transferring the first fluid from the second subterranean formation to the first subterranean formation. In some embodiments, the transferring the first fluid from the second subterranean formation to the first subterranean formation is performed after operation 508. In some embodiments, transferring the first fluid from the second subterranean formation to the first subterranean formation includes operating the electrical submersible generator as a pump.

Systems and methods of the present disclosure facilitate the operation of power systems, such as geothermal power systems, while mitigating the need for extensive fluid storage at the earth's surface (such as in ponds).

It is contemplated that any one or more elements or features of any one disclosed embodiment may be beneficially incorporated in any one or more other non-mutually exclusive embodiments. While the foregoing is directed to embodiments of the present disclosure, other and further embodiments of the disclosure may be devised without departing from the basic scope thereof, and the scope thereof is determined by the claims that follow.

What is claimed is:

1. A method of operating a power system, comprising:
producing a first fluid from a first subterranean formation;
generating electricity using the first fluid;
injecting the first fluid into a second subterranean formation different from the first subterranean formation; and
transferring the first fluid from the second subterranean formation to the first subterranean formation.

2. The method of claim 1, wherein:
the producing the first fluid from the first subterranean formation is performed at a first well; and
the injecting the first fluid into the second subterranean formation is performed at one of the first well or a second well different from the first well.

3. The method of claim 2, wherein the transferring the first fluid from the second subterranean formation to the first subterranean formation comprises pumping the first fluid into the first subterranean formation via the first well.

4. The method of claim 1, wherein the generating electricity using the first fluid comprises flowing the first fluid through a turbine coupled to a generator.

5. The method of claim 1, wherein the generating electricity using the first fluid comprises:
flowing the first fluid to a heat exchanger;
using heat of the first fluid to increase a temperature of a second fluid at the heat exchanger;
flowing the second fluid through an expander coupled to a generator; and
generating the electricity using the generator.

6. The method of claim 1, wherein the generating electricity using the first fluid comprises flowing the first fluid through an impeller section of an electrical submersible generator.

7. The method of claim 6, wherein:
the electrical submersible generator is installed in a well;
the producing the first fluid from the first subterranean formation is performed in the well; and
the injecting the first fluid into the second subterranean formation is performed in the well.

8. The method of claim 7, wherein transferring the first fluid from the second subterranean formation to the first subterranean formation comprises operating the electrical submersible generator as a pump.

9. A method of operating a power system, comprising:
producing a fluid from a first subterranean formation at a first zone of a well;
flowing the fluid through an impeller section of an electrical submersible generator installed in the well;
generating electricity using the electrical submersible generator; and
injecting the fluid into a second subterranean formation at a second zone of the well.

10. The method of claim 9, further comprising transferring the fluid from the second subterranean formation to the first subterranean formation.

11. The method of claim 10, wherein the transferring the fluid from the second subterranean formation to the first subterranean formation comprises:
producing the fluid from the second subterranean formation at the second zone of the well; and
injecting the fluid into the first subterranean formation at the first zone of the well.

12. The method of claim 10, wherein the transferring the fluid from the second subterranean formation to the first subterranean formation further comprises operating the electrical submersible generator as a pump.

13. The method of claim 9, wherein:
the electrical submersible generator comprises a motor coupled to one or more impellers of the impeller section; and
generating electricity using the electrical submersible generator comprises driving the motor using the one or more impellers.

14. The method of claim 9, wherein:
the electrical submersible generator comprises a motor coupled to one or more impellers of the impeller section; and
a generator coupled to the one or more impellers.

15. The method of claim 14, wherein generating electricity using the electrical submersible generator comprises driving the generator using the one or more impellers.

16. The method of claim 15, wherein the motor is decoupled from the one or more impellers while driving the generator using the one or more impellers.

17. A system comprising:
a well intersecting a first subterranean formation and a second subterranean formation;
an electrical submersible generator installed in the well;
a packer coupled to the electrical submersible generator, the packer located between the first and second subterranean formations, and sealing against a casing string of the well;
wherein the electrical submersible generator is configured to:
generate electricity when a fluid flows in the well from the first subterranean formation to the second subterranean formation; and
pump the fluid from the second subterranean formation to the first subterranean formation.

18. The system of claim 17, wherein the electrical submersible generator comprises a motor coupled to one or more impellers via a shaft.

19. The system of claim 18, wherein the electrical submersible generator further comprises a generator coupled to the one or more impellers via the shaft.

20. The system of claim 19, wherein one of the motor or the generator is configured to be selectively decoupled from the shaft.
